(19) United States
(12) Patent Application Publication
(10) Pub. No.: US 2020/0322621 A1
(43) Pub. Date: Oct. 8, 2020

(54) VIDEO DECODER AND MANUFACTURING METHOD THEREFOR, AND DATA PROCESSING CIRCUIT, SYSTEM AND METHOD

(71) Applicant: SZ DJI TECHNOLOGY CO., LTD., Shenzhen (CN)

(72) Inventors: Jianhua ZHANG, Shenzhen (CN); Yunsheng SUN, Shenzhen (CN); Chengzhang YANG, Shenzhen (CN); Bin HAN, Shenzhen (CN)

(21) Appl. No.: 16/909,576

(22) Filed: Jun. 23, 2020

Related U.S. Application Data
(63) Continuation of application No. PCT/CN2017/120016, filed on Dec. 29, 2017.

(51) Int. Cl. H04N 19/44; H04N 19/12; H04N 19/91; H04N 19/436; H04N 19/186; H04N 19/164

(52) U.S. Cl. CPC H04N 19/44; H04N 19/12; H04N 19/164; H04N 19/436; H04N 19/186; H04N 19/91

(57) ABSTRACT

A video decoder includes a stream dividing circuit configured to divide a stream to obtain a plurality of sub-streams, a processing circuit including a plurality of processing units configured to perform entropy decoding and inverse quantization on the plurality of sub-streams in parallel to obtain inversely quantized data, an inverse transform circuit configured to inversely transform the inversely quantized data to obtain inversely transformed data, and an output circuit configured to output a decoded video according to the inversely transformed data.

### CROSS-REFERENCE TO RELATED APPLICATION

This application is a continuation of International Application No. PCT/CN2017/120016, filed Dec. 29, 2017, the entire content of which is incorporated herein by reference.

### TECHNICAL FIELD

The present disclosure relates to video encoding and decoding technologies, and more particularly, to a video decoder and a manufacturing method therefor, and a data processing method, a circuit, and a system.

### BACKGROUND

Video codec technology can compress video data, thereby facilitating the storage and transmission of video data. Currently, video codec technology is widely used in various fields, such as mobile terminals and image transmission of unmanned aerial vehicles.

The video decoding process is an inverse process of the video encoding process, and generally includes stream dividing, entropy decoding, inverse quantization, and inverse transform, and etc.

Video decoding efficiency is an important factor for evaluating video decoders. How to improve video decoding efficiency has been a hot topic in the industry.

### SUMMARY

In accordance with the disclosure, there is provided a video decoder including a stream dividing circuit configured to divide a stream to obtain a plurality of sub-streams, a processing circuit including a plurality of processing units configured to perform entropy decoding and inverse quantization on the plurality of sub-streams in parallel to obtain inversely quantized data, an inverse transform circuit configured to inversely transform the inversely quantized data to obtain inversely transformed data, and an output circuit configured to output a decoded video according to the inversely transformed data.

Also in accordance with the disclosure, there is provided a method for manufacturing a video decoder including providing a stream dividing circuit configured to divide a received stream to obtain a plurality of sub-streams, and providing a processing circuit at an output end of the stream dividing circuit. The processing circuit includes a plurality of processing units configured to perform entropy decoding and inverse quantization on the plurality of sub-streams in parallel to obtain inversely quantized data. The method further includes providing an inverse transform circuit at an output end of the processing circuit to inversely transform the inversely quantized data to obtain inversely transformed data, and providing an output circuit at an output end of the inverse transform circuit to output a decoded video according to the inversely transformed data.

Also in accordance with the disclosure, there is provided a data processing circuit including an interface circuit configured to be connected to a post-stage circuit of the data processing circuit and a processing circuit configured to detect a ready signal sent by the post-stage circuit, start processing the target data in response to the ready signal being valid, and send processed data to the post-stage circuit.

### BRIEF DESCRIPTION OF THE DRAWINGS

FIG. 1 is a schematic structural diagram of a video decoder according to some example embodiments.

FIG. 2 is a diagram illustrating a relationship among image frames, slices, streams, and sub-streams in a video.

FIG. 3 is a schematic structural diagram of a processing unit in FIG. 1.

FIG. 4 is a schematic structural diagram of a VLD circuit in FIG. 3.

FIG. 5 is a schematic structural diagram of a re-quantization circuit in FIG. 3.

FIG. 6 is a schematic structural diagram of another video decoder according to some example embodiments.

FIG. 7 is a schematic structural diagram of an output circuit in FIG. 1.

FIG. 8 is a diagram illustrating a connection manner between a processing circuit and an inverse transformation circuit according to some example embodiments.

FIG. 9 is a diagram illustrating another connection manner between a processing circuit and an inverse transformation circuit according to some example embodiments.

FIG. 10 is a schematic diagram of an interaction manner between a pre-stage circuit and a post-stage circuit in a data processing system.

FIG. 11 is a schematic diagram of a sequential logic of a pre-stage circuit according to some example embodiments.

FIG. 12 is a sequential logic diagram of a pre-stage circuit according to some example embodiments.

FIG. 13 is a schematic flowchart of a method for manufacturing a video decoder according to some example embodiments.

FIG. 14 is a schematic structural diagram of a data processing circuit according to some example embodiments.

FIG. 15 is a schematic structural diagram of a data processing system according to some example embodiments.

FIG. 16 is a schematic flowchart of a data processing method according to some example embodiments.

### DETAILED DESCRIPTION OF THE EMBODIMENTS

In order to facilitate understanding, the process of video encoding and decoding is introduced first.

A video encoder generally includes a dividing circuit, a transform domain encoding circuit, a quantization circuit, an encoding circuit, a stream output circuit, and the like. In some embodiments, the video encoder may further include a filter circuit, a bit rate control circuit, and the like.

The dividing circuit can divide an image frame to one or more data units that can be independently encoded and decoded. The data unit divided by the dividing circuit can be a piece of image in an image frame. This piece of image can be referred to as a slice, which will be used as an example in this disclosure.

The transform domain encoding circuit can convert the data to be encoded into the frequency domain, and reduce the correlation (such as spatial correlation) of the image data from the perspective of the frequency domain to reduce the bit rate. There are multiple transformation methods corresponding to the transform domain encoding, such as Fourier transform (FT) or discrete cosine transform (DCT).

The quantization circuit mainly uses the characteristic that the human eye is less sensitive to high-frequency signals, and discards part of the high-frequency information in the image, thereby limiting the value of the encoded data to a certain range to further reduce the bit rate.

The encoding circuit can encode image data by using run-length encoding and/or entropy encoding. Run-length encoding and entropy encoding are both lossless encoding. Run-length encoding can make full use of the characteristics of consecutive image blocks and represent the image blocks with two factors of run-level, thereby further simplifying the data. Entropy encoding may be Huffman coding, or arithmetic coding, or others. Entropy encoding can represent high-frequency data with fewer data streams to achieve lossless compression of high-frequency data.

The bit rate control circuit usually uses prediction and other methods to calculate the quantization value used by the slice to be encoded. The bit rate control circuit can add header information to the beginning of the bit stream to pack the bit stream for output.

The circuits of the video encoder listed above can be functional circuits. In some embodiments, different functional circuits can be implemented by the same or different hardware circuits, which is not limited in this disclosure.

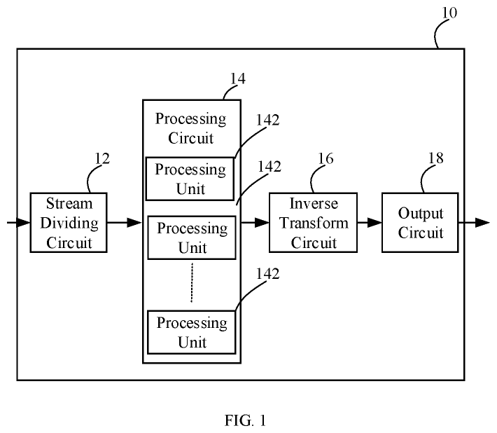

The video decoding process is the inverse process of the video encoding process and usually includes operations such as stream dividing, entropy decoding, inverse quantization, and inverse transform, and etc. The video decoder 10 according to some embodiments of this disclosure that can improve the video decoding efficiency is described in detail below with reference to FIG. 1.

As shown in FIG. 1, the video decoder 10 generally includes a stream dividing circuit 12, a processing circuit 14, an inverse transform circuit 16, and an output circuit 18.

The stream dividing circuit 12 may also be referred to as a stream random access memory control (stream RAM control) circuit. The stream dividing circuit 12 can be configured to divide the received stream to multiple sub streams (or stream blocks). The sub-stream can be decoded independently. For example, the sub-stream can be obtained by encoding slice data. Correspondingly, the sub-stream can also be referred to as slice coded stream.

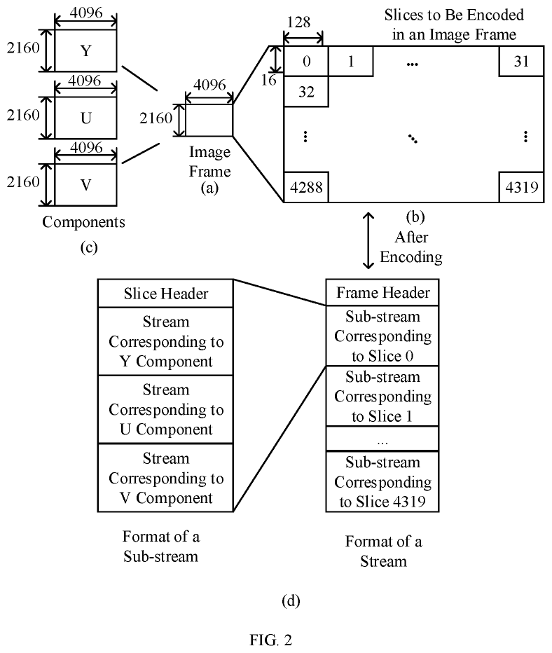

The relationship between the image frame, the slice, the stream, and the sub-stream is related to factors such as the image frame size, the codec protocol and others, which is not limited in the embodiments of this disclosure. A video of the 4K 444 specification as an example is shown is FIG. 2. As shown in part (a) of FIG. 2, the size of an image frame in a video of the 4K 444 format is 4096×2160. As shown in part (b) of FIG. 2, one image frame can be divided into units with a size of 128×16, and a total of 4320 slices are obtained. Each slice can be independently coded. An image pixel usually contains multiple components, such as RGB components, or YUV components, as shown in part (c) of FIG. 2. After the image frame shown in part (a) of FIG. 2 is encoded, a stream having a container format shown in part (d) of FIG. 2 can be obtained. The stream includes a frame header, and frame data corresponding to the frame header may include the stream information formed by 4320 sub-streams. Part (d) of FIG. 2 shows a container format of the sub-stream. As shown in part (d) of FIG. 2, the sub-stream includes a slice header and stream information corresponding to Y, U, and V components.

The processing circuit 14 can also be referred to as a stream decoding circuit (or a PE unit, where PE is an abbreviation of “process element”). The processing circuit 14 includes a plurality of processing units 142. The plurality of processing units 142 can be configured to perform entropy decoding and inverse quantization on multiple sub-streams to obtain inversely quantized data. The entropy decoding process of multiple sub-streams by multiple processing units 142 can be performed in parallel; and/or the inverse quantization process of multiple sub-streams by multiple processing units 142 can be performed in parallel.

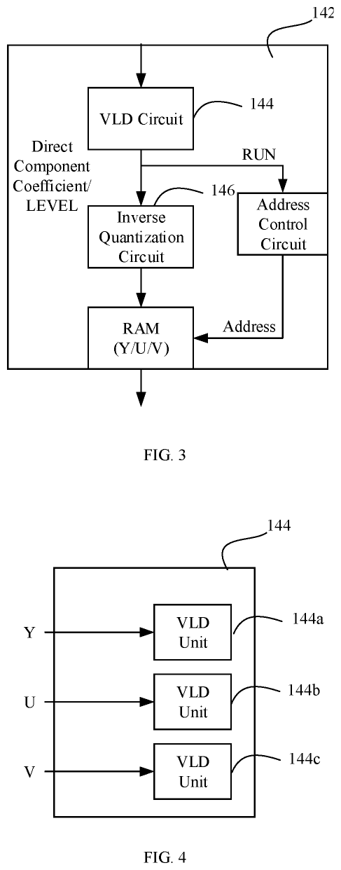

As an example, the encoding end performing the entropy encoding in a run-length encoding manner is described. As shown in FIG. 3, in the processing circuit 142, a variable length decoder (VLD) 144 is first used to decode sub-streams with different lengths into characters of equal length (for example, a dictionary can be used to decode). Then, the inverse quantization circuit 146 is used to multiply the characters (for example, including direct component (DC) coefficients and/or LEVEL information obtained by encoding) formed by the VLD circuit 144 by decoding to obtain inverse quantization data. Then, based on the Run information, the inverse quantization data can be written into RAM with the corresponding address under the control of the address controller to restore the slice data after transformation and before quantization.

Further, in some embodiments, the processing unit 142 can be configured to perform parallel entropy decoding and/or parallel inverse quantization on data in the corresponding sub-streams (i.e., the sub-streams processed by the processing unit 142) for each color component.

The color components of different image domains are different, and the form of the color components is not limited in this disclosure. For example, a luminance component and/or a chrominance component can be included. In one example, the image data is in RGB color space, and the color components are R component, G component, and B component. In another example, the image data is in a YUV color space, and the color components are a Y component, a U component, and a V component.

A YUV color space is shown as an example in FIG. 4. The VLD circuit 144 is further divided into a VLD unit 144a, a VLD unit 144b, and a VLD unit 144c. The VLD unit 144a, the VLD unit 144b, and the VLD unit 144c can be used to perform independent variable-length decoding on the Y component, U component, and V component of image data, respectively.

The inverse transform circuit 16 (which can include one or more inverse transformers) can be configured to perform an inverse transform on the inverse data output from the processing circuit 14. There are multiple inverse transformation methods, such as inverse discrete cosine transformation (IDCT), inverse Fourier transform, or others.

The YUV color space is shown as another example in FIG. 5. The inverse quantization circuit 146 can be further divided into an inverse quantization unit 146a, an inverse quantization unit 146b, and an inverse quantization unit 146c. The inverse quantization unit 146a, inverse quantization unit 146b, and inverse quantization unit 146c can be respectively used to perform independent inverse quantization on the Y component (including the DC coefficient and/or LEVEL information corresponding to the Y component), the U component (including the DC coefficient corresponding to the U component and/or LEVEL information) and V component (including the DC coefficient and/or LEVEL information corresponding to the V component). As shown in FIG. 5, the inverse quantization circuit 146 includes three inverse quantization units, and the three inverse quantization units are respectively used to process inverse quantization data corresponding to different color components. The number of inverse quantization units included in the circuit 146 and the number of color components processed by each inverse quantization unit are not specifically limited in this disclosure. For example, the inverse quantization circuit 146 can include one inverse quantization unit, and the inverse quantization unit can process the inverse quantization data corresponding to the three color components. For another example, the inverse quantization circuit 146 can include two inverse quantization units. One of the inverse quantization units can process the inverse quantization data corresponding to two color components, and the other inverse quantization unit can process the inverse quantization data corresponding to the remaining one color component.

The output circuit 18 can be referred to as a write memory access unit (WR MAU). The output circuit 18 can be configured to output decoded video information. For example, the output circuit 18 can output the decoded video information (such as writing the decoded video information to a memory or a video playback module) through an external transmission line (such as an advanced eXtensible interface (AXI) bus).

Multiple parallel processing units are employed in the embodiments of this disclosure to perform parallel processing on sub-streams, therefore improving video decoding efficiency.

In some embodiments, after the inverse transform circuit 16 processes the data and before the output circuit 18 outputs the decoded video, the image data after the inverse transform can also be transformed into different image domains, so that image data can be processed in different image domains. For example, image data can be switched from the YUV domain to the RGB domain for processing, and vice versa.

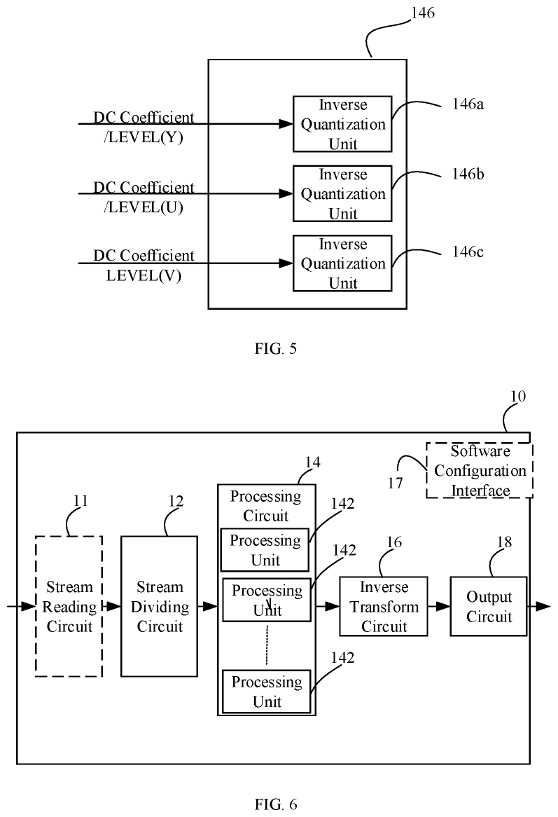

In some embodiments, as shown in FIG. 6, the video decoder 10 further includes an external software configuration interface 17, such as an advanced peripheral bus (APB) interface or an AXI-Lite interface. Through the software configuration interface 17, a configuration register (CFG REG, not shown in the figure) of the video decoder 10 can be configured, so that the decoding method of the video decoder 10 can be adjusted or controlled.

In some embodiments, as shown in FIG. 6, the video decoder 10 further includes a stream reading circuit 11. The stream reading circuit 11 is also referred to as a stream memory access unit (stream MAU). The stream reading circuit 11 is configured to use an AXI bus or other types of data transmission lines to read the stream into the video decoder 10 and parse the header information of the stream.

The output circuit 18 may include one output interface (or a set of output interfaces), or may include a plurality of output interfaces (or a plurality of sets of output interfaces). The video decoder 10 connected to other components in the system through a bus (such as the AXI bus) is taken as an example. The output interface is also referred to as a write bus interface or a write interface. When the output circuit 18 includes multiple output interfaces (or multiple sets of output interfaces), the video decoder 10 further includes a switch circuit (not shown in the figure). The switch circuit can be configured to control on and off of at least one output interface (or at least one set of output interfaces). There are many ways to control the switch circuit. For example, the switch circuit can be controlled manually, or automatically based on the information of the video decoder 10 and the environmental information of the video decoder 10 detected by the detection circuit. The environmental information includes the throughput of the output interface connected to the bus, the operating frequency of the system that the video decoder is working with, the operating frequency of the video decoder, and the format of the image in the stream.

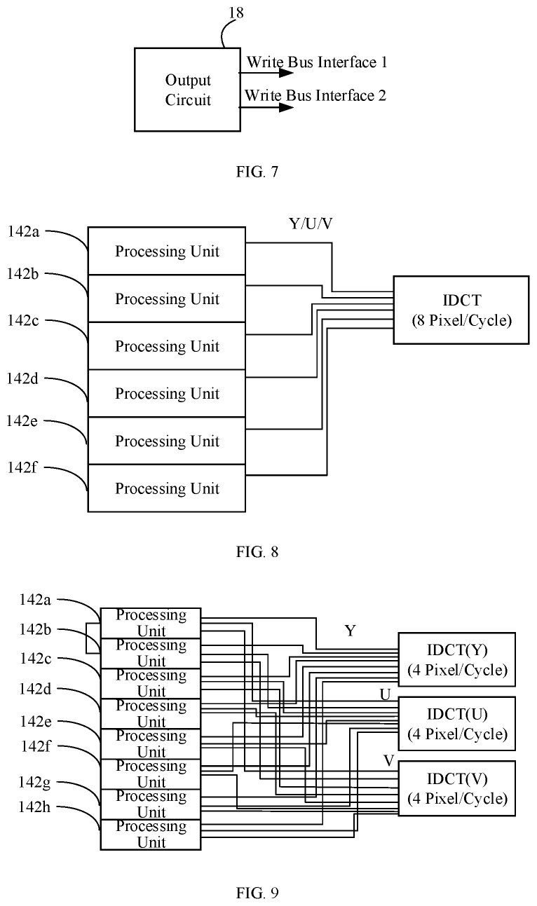

As shown in FIG. 7, two output interfaces can be set for the output circuit 18 in advance, e.g., the write bus interface 1 and the write bus interface 2. The video decoder 10 can work with one output interface or two output interfaces based on actual needs. When two output interfaces work at the same time, the video decoder 10 can output the decoded video in parallel through the two output interfaces to improve the efficiency of outputting video information.

In this disclosure, the number of output interfaces configured to the video decoder can be decided according to actual conditions, so that the output manner of the decoded video is more flexible.

The inverse transform circuit 16 can implement parallel multi-pixel inverse transformation. The number of pixels of the inverse transformation is related to the specification or deployment of the inverse transform circuit 16, which is not limited in this disclosure. Taking an inverse transformation of 8×8 as an example, two one dimensional (1D) inverse transformers can be deployed to perform a transposition to achieve 8 pixels per cycle (or 8 pixels/cycle) parallel inverse transformation. As another example, a one dimensional inverse transformer can be deployed to implement 4 pixels per cycle (or 4 pixels/cycle) parallel inverse transformation, and the data to be inversely transformed can use the one-dimensional inverse transformer at different times repeatedly. As another example, a 16-pixel parallel inverse transformation can be achieved by deploying a faster inverse transformer or multiple slower inverse transformers. Since the inverse transformer can perform multi-pixel parallel processing, in general, the processing of the inversely transformed data by the inverse transformer is faster than the processing of a sub-stream by a processing unit 142 in the processing circuit 14. If the processing speeds of the two circuits are not matched, the processing resources of the inverse transform circuit 16 may be wasted. In the following embodiments, a speed matching method used between the processing circuit 14 and the inverse transform circuit 16 is described in detail.

In some embodiments, the inverse transform circuit 16 may include multiple inverse transformers, which are used to process different color components of the sub-stream.

In some embodiments, the number P of processing units connected to the inverse transformer can be equal to the rounding up result of dividing M₁ by N₁, M₁ represents the time (or the longest time required) for the processing unit to complete the processing of a color component of a sub-stream, and N₁ represents the time for the inverse transformer to complete the processing of a color component of a sub-stream.

The specific values of P, M₁, and N₁ may be related to the size of the slice in the sub-stream and the specifications of the inverse transformer, which is not limited in this disclosure. For example, the size of a slice in the sub-stream is 128×16 and the IDCT can process 4 pixels per cycle. Since the specification of the IDCT is 4 pixels per cycle, it usually takes 512 cycles for the IDCT to complete the inverse transformation of one color component of a slice. It takes at most 4096 cycles for the processing unit 142 to complete decoding of one slice. Since the result of 4096/512 is equal to 8, 8 processing units 142 (that is, processing units 142a to 142h in FIG. 9) can be connected to 3 IDCTs, so that the speed of 8 processing units 142 matches the speed of three 4-pixel per cycle IDCTs. With the speed matching results shown in FIG. 9, a real-time decoding of 8K 444 @ 30 fps video can be realized.

Alternatively, the inverse transform circuit 16 can include an inverse transformer. The inverse transformer can be utilized to process the three color components of a sub-stream.

In some embodiments, the number Q of processing units connected to the inverse transformer equals the rounding up result of dividing M₂ by N₂, M₂ represents the time (or the longest time required) for the processing unit to complete the processing of one color component of a sub-stream, and N₂ represents the time for the inverse transformer to complete the processing of the three color components of a sub-stream.

The specific values of Q, M₂, and N₂ may be related to the size of the slice in the sub-stream and the specifications of the inverse transformer, which is not limited in this disclosure. For example, the size of a slice in the sub-stream is 128x16 and the inverse transformer is IDCT. Since the specification of the IDCT is 8 pixels per cycle, it usually takes 768 (256x3=768) cycles for the IDCT to complete the inverse transformation of one slice (including Y, U and V three components). It takes at most 4096 cycles for the processing unit 142 to complete decoding of one slice. Since the rounding up result of 4096/768 equals 6, 6 processing units 142 (that is, processing units 142a to 142f in FIG. 8) can be connected to one IDCT with 8 pixels per cycle, so that the speed of 6 processing units 142 matches the speed of one IDCT. With the speed matching structure shown in FIG. 8, a real-time decoding of 4K 444 @ 60 fps video or 6K 444 @ 30 fps video can be realized.

As shown in FIG. 1, a video decoder 10 is usually configured to connect a plurality of data processing circuits (or multiple circuits) in sequence, such as a stream dividing circuit 12, a processing circuit 14, an inverse transform circuit 16, and the like. In the video decoder 10, two adjacent data processing circuits are pre-stage (immediately preceding) circuit and post-stage (immediately succeeding) circuit to each other. Taking the inverse transform circuit 16 in FIG. 1 as the data processing circuit as an example, the pre-stage circuit of the inverse transform circuit 16 is the processing circuit 14; accordingly, the post-stage circuit of the processing circuit 14 is the inverse transform circuit 16.

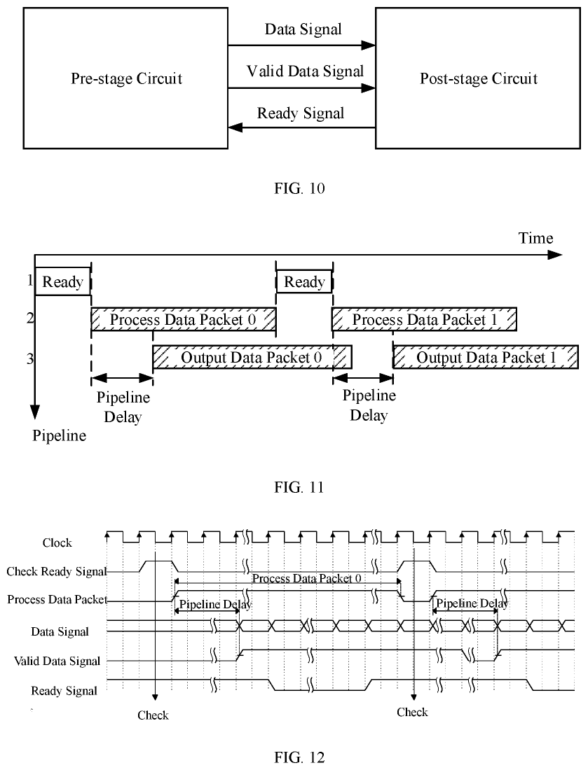

As shown in FIG. 10, the pre-stage circuit and the post-stage circuit can be connected through an interface. From the perspective of the post-stage circuit, the common interface signals generally include data signals (also referred to as input data), valid data signals (also referred to as input data valid), and ready signals (output ready). The pre-stage circuit can pass the processed data to the post-stage circuit for the post-stage circuit to continue processing. The post-stage circuit can send a ready signal to the pre-stage circuit to feedback the status thereof, so as to indicate whether the post-stage circuit is ready to receive the data signal from the pre-stage circuit. For example, when the ready signal of the post-stage circuit is valid, the data signal and the valid data signal sent by the pre-stage circuit can be accepted, otherwise the post-stage circuit does not accept the data signal and the valid data signal sent by the previous circuit.

A ready signal corresponds to a valid data signal. When the ready signal is invalid, the pre-stage circuit needs to suspend the processing in time (stall), or additional storage (such as RAM) can be introduced to the pre-stage circuit as a buffer for some output results. The first method will introduce more control or logic processing to the pre-stage circuit, thereby increasing the pipelines stage of the pre-stage circuit. As a result, the pre-stage circuit becomes more complicated, less portable and less scalable. The latter method will increase the consumption of storage resources of the video decoder.

In order to solve the above problems, the data processing circuit of the video decoder 10 provided in the embodiments of this disclosure can be configured to perform the following operations: detecting a ready signal sent by the post-stage circuit of the data processing circuit; processing the target data when the ready signal is detected as valid and sending the processed data to the post-stage circuit. The data processing circuit can be further configured that the processing time of the target data by the data processing circuit and the sending time of the processed data partially overlap. The overlapping time can be determined by the pipeline stage inside the data processing circuit, which is not limited in this disclosure.

In some embodiments, after receiving the ready signal sent by the post-stage circuit, the pre-stage circuit starts to process the data. In other words, the start of the data processing of the pre-stage circuit can be controlled by the ready signal sent by the post-stage circuit. This kind of data processing and interaction mode can ensure the correct transmission of data and avoid introducing complex control logic or introducing excessive storage resources to the video decoder.

FIGS. 11 and 12 shows a logic sequence of the internal pipeline of the data processing circuit is provided. As shown in FIGS. 11 and 12, the data processing circuit first checks the status of the ready signal of the post-stage circuit. When the ready signal is valid (ready in FIG. 11 indicates that the ready signal is valid), the data processing circuit starts processing the data packet. After a certain delay, the processed data packet is output to the post-stage circuit. The delay time depends on the structure of the pipeline stage inside the data processing circuit, so the delay is also referred to as a pipeline delay, which is not limited in this disclosure. The data processing circuit repeats the above process until all the data is processed.

In some embodiments, a data packet is taken as a unit, an overall handshaking and data interaction mode are introduced. A data packet is a set of data of the same type. As shown in FIG. 1, if the stream dividing circuit 12 is the data processing circuit, the data packet may be the stream data to be divided. If the inverse transform circuit 16 is the data processing circuit, the data packet may be the inverse quantization data output by the processing circuit 14.

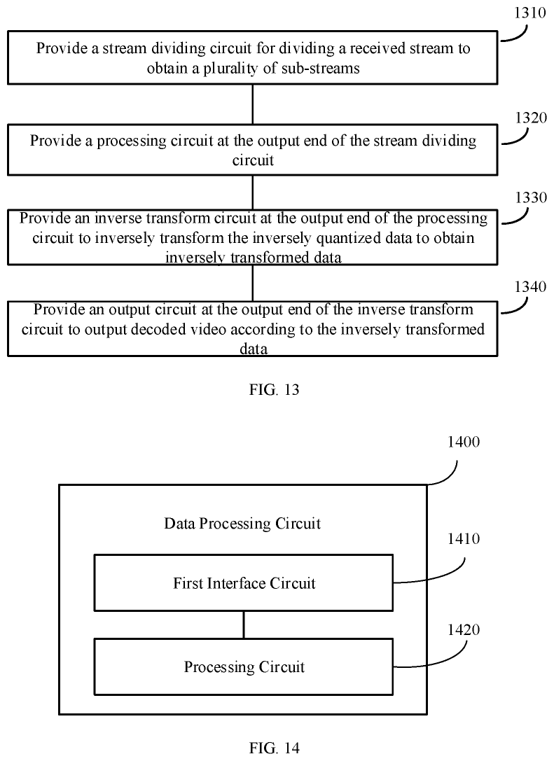

The video decoder provided by the embodiments of this disclosure is described in detail with reference to FIGS. 1-12. As shown in FIG. 13, in some embodiments, a method of manufacturing the video decoder is provided. The descriptions of the method and the device correspond to each other, and therefore, for the parts that are not described in detail, reference can be made to the corresponding description for the device.

FIG. 13 is a schematic flowchart of a method for manufacturing a video decoder consistent with the disclosure. At 1310, a stream dividing circuit for dividing the received stream is provided to obtain a plurality of sub-streams.

At 1320, a processing circuit is provided at the output end of the stream dividing circuit. The processing circuit includes multiple processing units, which can perform entropy decoding and inverse quantization on multiple sub-streams in parallel to obtain inversely quantized data.

At 1330, an inverse transform circuit is provided at the output end of the processing circuit to inversely transform the inversely quantized data to obtain inversely transformed data.

At 1340, an output circuit is provided at the output end of the inverse transform circuit to output decoded video according to the inversely transformed data.

In some embodiments, at least one processing unit can be configured to perform entropy decoding and inverse quantization on data in the corresponding sub-stream in parallel for each color component.

In some embodiments, a color component may include a color component of an RGB color space, or a color component of a YUV color space.

In some embodiments, the inverse transform circuit may be configured such that a processing speed of the inverse quantization data by the inverse transform circuit matches a processing speed of the processing circuit on a plurality of sub-streams.

In some embodiments, the inverse transform circuit includes at least one inverse transformer and is configured at the output end of the processing circuit. The method shown in FIG. 13 may further include connecting the inverse transformer to a plurality of processing units.

In some embodiments, the number of processing units corresponding to the inverse transformer may be determined based on at least one of the following factors: the transformation rate of the inverse transformer, the data processing rate of the processing circuit, the amount of data of the sub-stream, the coding complexity of the sub-stream.

In some embodiments, the inverse transform circuit may include an inverse transformer. The method of connecting the inverse transformer to a plurality of processing units may include: connecting the inverse transformer to 6 processing units. The inverse transformer is configured to receive inversely quantized data corresponding to each color component from 6 processing units, and perform one-dimensional inverse transform with 8-pixel per cycle on the inversely quantized data corresponding to each color component.

In some embodiments, the inverse transform circuit may include three inverse transformers in parallel. The method of connecting the inverse transformer to a plurality of processing units may include: connecting the inverse transformer to 8 processing units. The inverse transformer is configured to receive inversely quantized data corresponding to each color component from 8 processing units, and perform one-dimensional inverse transform with 4 pixels per cycle on the inversely quantized data corresponding to each color component.

In some embodiments, the output circuit may include multiple output interfaces. The method shown in FIG. 13 may further include providing a switch circuit to control on and off of at least one output interface.

In some embodiments, the method shown in FIG. 13 may further include providing a detection circuit to detect at least one of the following information: the throughput of the output interface connected to the bus, the operating frequency of the system that the video decoder is working with, the operating frequency of the video decoder, and the format of the image in the stream. The switch circuit can be configured to control on and off of at least one output interface according to the information detected by the detection circuit.

In some embodiments, the data processing circuit in the video decoder may be configured to perform the following operations: detecting a ready signal sent by a post-stage circuit of the data processing circuit; starting processing the target data when a valid ready signal is detected; and sending the processed data to the post-stage circuit.

In some embodiments, the data processing circuit may be configured such that the processing time of the target data by the data processing circuit and the sending time of the processed data partially overlap.

In some embodiments, the data processing circuit and the post-stage circuit can be connected through a data line and a data valid line. Sending the processed data to the post-stage circuit may include sending the processed data to the post-stage circuit through the data line when the signal on the data valid line is valid.

In a data processing system (a video decoder 10 shown in FIG. 1 is a typical data processing system), multiple data processing circuits (or multiple circuits) are usually configured to form a data pipeline. As shown in FIG. 1, the multiple processing circuits are the stream dividing circuit 12, the processing circuit 14, the inverse transform circuit 16, etc. In the video decoder 10, two adjacent data processing circuits are pre-stage circuit and post-stage circuit to each other. Taking the video decoder 10 shown in FIG. 1 as the data processing system and the inverse transform circuit 16 in FIG. 1 as the data processing circuit as an example, the pre-stage circuit of the inverse transform circuit 16 is the processing circuit 14; accordingly, the post-stage circuit of the processing circuit 14 is the inverse transform circuit 16.

The pre-stage circuit and the post-stage circuit can be connected through an interface. From the perspective of the post-stage circuit, the common interface signals generally include data signals (also referred to as input data), valid data signals (also referred to as input data valid), and ready signals (output ready). The pre-stage circuit can pass the processed data to the post-stage circuit for the post-stage circuit to continue processing. The post-stage circuit can send a ready signal to the pre-stage circuit to feedback the status thereof, so as to indicate whether the post-stage circuit is ready to receive the data signal from the pre-stage circuit. For example, when the ready signal of the post-stage circuit is valid, the data signal and the valid data signal sent by the pre-stage circuit can be accepted, otherwise the post-stage circuit does not accept the data signal and the valid data signal sent by the previous circuit.

A ready signal corresponds to a valid data signal. When the ready signal is invalid, the pre-stage circuit needs to suspend the processing in time (stall), or additional storage (such as RAM) can be introduced to the pre-stage circuit as a buffer for some output results. The first method will introduce more control or logic processing to the pre-stage circuit, thereby increasing the pipelines stage of the pre-stage circuit. As a result, the pre-stage circuit becomes more complicated, less portable and less scalable. The latter method will increase the consumption of storage resources of the video decoder.

In order to solve the above problems, a data processing circuit is provided in the embodiments of this disclosure. The data processing circuit can be utilized in the video decoder 10 and any other kinds of data processing systems, which is not limited in this disclosure.

As shown in FIG. 14, in some embodiments, the data processing circuit 1400 includes a first interface circuit 1410 and a processing circuit 1420. The first interface circuit 1410 may be configured to connect to a post-stage circuit of the data processing circuit 1400. The processing circuit 1420 may be configured to detect a ready signal sent by a post-stage circuit, start processing the target data when a valid ready signal is detected, and send the processed data to the post-stage circuit. In this disclosure, the manner in which the processing circuit 1420 sends the processed data to the post-stage circuit is not limited. For example, the first interface circuit 1410 may include a data line and a data valid line, and the processing circuit 1420 may be configured to send the processed data to the post-stage circuit through the data line when the signal on the data valid line is valid.

In some embodiments, after receiving the ready signal sent by the post-stage circuit, the data processing circuit 1400 as the pre-stage circuit starts to process the data. In other words, the start of the data processing of the pre-stage circuit can be controlled by the ready signal sent by the post-stage circuit. This kind of data processing and interaction mode can ensure the correct transmission of data and avoid introducing complex control logic or introducing excessive storage resources to the video decoder.

FIGS. 11 and 12 shows a logic sequence of the internal pipeline of the data processing circuit is provided. As shown in FIGS. 11 and 12, the data processing circuit first checks the status of the ready signal of the post-stage circuit. When the ready signal is valid (“Ready” in FIG. 11 indicates that the ready signal is valid), the data processing circuit starts processing the data packet. After a certain delay, the processed data packet is output to the post-stage circuit. The delay time depends on the structure of the pipeline stage inside the data processing circuit, so the delay is also referred to as a pipeline delay, which is not limited in this disclosure. The data processing circuit repeats the above process until all the data is processed.

In some embodiments, a data packet is taken as a unit, an overall handshaking and data interaction mode are introduced. A data packet is a set of data of the same type. As shown in FIG. 1, if the stream dividing circuit 12 is the data processing circuit, the data packet may be the stream data to be divided.

In some embodiments, the processing circuit 1420 can be further configured that the processing time of the target data by the data processing circuit and the sending time of the processed data partially overlap. The overlapping time can be determined by the pipeline stage inside the data processing circuit, which is not limited in this disclosure.

In some embodiments, the data processing circuit 1400 may further include a second interface circuit. The data processing circuit 1400 can connect to a pre-stage circuit of the data processing circuit 1400 through the second interface circuit. The processing circuit 1420 may be further configured to set the ready signals of the pre-stage circuit and the data processing circuit as invalid signals when the data of the pre-stage circuit is received. In some embodiments, the data processing circuit 1400 is used as a post-stage circuit. When a data packet sent by the pre-stage circuit is received, the ready signal between the data processing circuit 1400 and the pre-stage circuit of the data processing circuit 1400 is set as invalid. As a result, a wrong judgment of the ready signal state caused by the delay of the control pipeline in the pre-stage circuit is avoided.

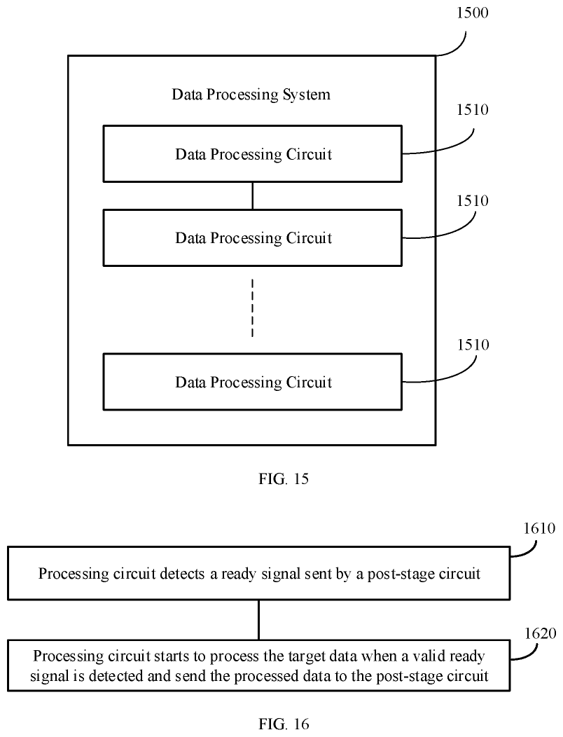

This disclosure also provides a data processing system. The data processing system can be the video decoder 10 as described above, or another type of data processing system, which is not limited in this disclosure. As shown in FIG. 15, the data processing system 1500 includes a plurality of data processing circuits 1510 connected in sequence. At least one or more of the plurality of processing circuits 1510 are the data processing circuit 1400 as shown in FIG. 14.

In some embodiments, the data processing system 1500 also includes multiple output interfaces and a switch circuit to control on and off of at least one output interface.

In some embodiments, the data processing system 1500 also includes a detection circuit to detect at least one of the following information: the throughput of the output interface connected to the bus, the main operating frequency of the computer system where the data processing system locates at, the operating frequency of the data processing system, and the format of the data processed by the processing system. The switch circuit can be configured to control on and off of at least one output interface according to the information detected by the detection circuit.

The data processing circuit provided by the embodiments of this disclosure is described in detail with reference to FIGS. 14 and 15. As shown in FIG. 16, in some embodiments, a data processing method of the data processing circuit is provided. The descriptions of the method and the device correspond to each other, and therefore, for the parts that are not described in detail, reference can be made to the corresponding description for the device.

The data processing circuit includes a first interface circuit and a processing circuit. The first interface circuit is configured to connect to the post-stage circuit. As shown in FIG. 16, the data processing method of the data processing circuit includes the processing circuit detecting a ready signal sent by the post-stage circuit (1610), and the processing circuit starting to process the target data when a valid ready signal is detected, and sending the processed data to the post-stage circuit (1620).

In some embodiments, the processing circuit is configured that the processing time of the target data and the transmission time of the processed data partially overlap.

In some embodiments, the first interface circuit includes a data line and a data valid line. At 1620, when the signal of the data valid line is valid, the processed data is sent to the post-stage circuit through the data line.

In some embodiments, the data processing circuit may further include a second interface circuit, and the second interface circuit is configured to connect to a pre-stage circuit of the data processing circuit. The method as shown in FIG. 16 may further include the processing circuit setting the ready signals of the pre-stage circuit and the data processing circuit as invalid signals when the data of the pre-stage circuit is received.

At 1310, a stream dividing circuit for dividing the received stream is provided to obtain a plurality of sub-streams.

At 1320, a processing circuit is provided at the output end of the stream dividing circuit. The processing circuit includes multiple processing units, which can perform entropy decoding and inverse quantization on multiple sub-streams in parallel to obtain inversely quantized data.

At 1330, an inverse transform circuit is provided at the output end of the processing circuit to inversely transform the inversely quantized data to obtain inversely transformed data.

At 1340, an output circuit is provided at the output end of the inverse transform circuit to output decoded video according to the inversely transformed data.

In some embodiments, at least one processing unit can be configured to perform entropy decoding and inverse quantization on data in the corresponding sub-stream in parallel for each color component.

With no conflict, the embodiments described in this disclosure and/or the technical features in each embodiment can be combined with each other, and the technical solution obtained after the combination should also fall into the scope of this disclosure.

The above embodiments can be implemented in whole or in part by software, hardware, firmware, or any other combination. Software can be implemented in whole or in part in the form of a computer program. The computer program includes one or more computer instructions. When the computer program instructions are loaded and executed on a computer, the processes or functions according to the embodiments of this disclosure are wholly or partially generated. The computer may be a general computer, a specialized computer, a computer network, or other programmable devices. The computer instructions may be stored in a computer-readable storage medium, or transmitted from one computer-readable storage medium to another computer-readable storage medium. For example, the computer instructions may be transmitted from a website site, a computer, a server, or a data center to another website site, computer, server or data center via wired (such as coaxial cable, optical fiber, digital subscriber line (DSL)) or wireless (such as infrared, wireless, microwave, etc.) methods. The computer-readable storage medium may be any available medium that can be accessed by a computer or a data storage device such as a server, a data center, or the like that includes one or more available medium integration. The usable medium may be a magnetic medium (for example, a floppy disk, a hard disk, a magnetic tape), an optical medium (for example, a digital video disc (DVD)), or a semiconductor medium (for example, a solid state disk (SSD)), etc.

To those of ordinary skill in the art, the units and algorithm of each example embodiments can be implemented by electronic hardware, or a combination of computer software and electronic hardware. Whether these functions are performed in hardware or software depends on the specific application and design constraints of the technical solution. A professional technician can use different methods to implement the described functions for each specific application, but such implementation should not be considered to be beyond the scope of this disclosure.

In some embodiments, the disclosed devices and methods may be implemented in other ways. The device embodiments described above are only schematic. For example, the division of the unit is only a logical function division. In actual implementation, there may be another division manner. For another example, multiple units or components may be combined or integrated into another system, or some features can be ignored or not implemented. In addition, the displayed or discussed mutual coupling or direct coupling or communication connection may be indirect coupling or communication connection through some interfaces, devices or units, which may be electrical, mechanical or other forms.

The units described as separate components may or may not be physically separated, and the components displayed as units may or may not be physical units, that is, the unites may be located in one place, or may be distributed on multiple network units. Some or all of the units may be selected according to actual needs to achieve the objective of the embodiment.

In addition, each functional unit in each embodiment of this disclosure may be integrated into one processing unit, or each of the units may exist separately physically, or two or more units may be integrated into one unit.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A video decoder comprising:
a stream dividing circuit configured to divide a stream to obtain a plurality of sub-streams;
a processing circuit including a plurality of processing units configured to perform entropy decoding and inverse quantization on the plurality of sub-streams in parallel to obtain inversely quantized data;
an inverse transform circuit configured to inversely transform the inversely quantized data to obtain inversely transformed data; and
an output circuit configured to output a decoded video according to the inversely transformed data.

2. The video decoder of claim 1, wherein the processing units are configured to perform the parallel entropy decoding and inverse quantization on data in the corresponding sub-streams for each color component.

3. The video decoder of claim 2, wherein the color component includes a color component in an RGB color space or a color component in a YUV color space.

4. The video decoder of claim 1, wherein the inverse transform circuit is configured such that a processing speed of the inverse quantization data by the inverse transform circuit matches a processing speed of the processing circuit on the plurality of sub-streams.

5. The video decoder of claim 4, wherein the inverse transform circuit includes a plurality of inverse transformers to process different color components of the sub-stream.

6. The video decoder of claim 5, wherein a number of processing units connected to one inverse transformer equals a rounding up result of dividing a time for one processing unit to complete processing one color component of one sub-stream by a time for the one inverse transformer to complete processing the one color component of the one sub-stream.

7. The video decoder of claim 6, wherein the inverse transform circuit includes three inverse transformers in parallel, each of the inverse transformers being connected with eight processing units and configured to:
receive inversely quantized data corresponding to one color component from the eight processing units; and
perform one-dimensional inverse transform with four pixels per cycle on the inversely quantized data corresponding to the one color component.

8. The video decoder of claim 4, wherein the inverse transform circuit includes one inverse transformer configured to process three color components of one sub-stream.

9. The video decoder of claim 8, wherein a number of processing units connected to the inverse transformer equals a rounding up result of dividing a time for one processing unit to complete processing one color component of one sub-stream by a time for the inverse transformer to complete processing the three color components of the one sub-stream.

10. The video decoder of claim 9, wherein the inverse transformer is connected with six processing units and is configured to:
receive inversely quantized data corresponding to respective color components from the six processing units; and
perform one-dimensional inverse transform with eight pixels per cycle on the inversely quantized data corresponding to the respective color components.

11. The video decoder of claim 1, further comprising:
a switch circuit;
wherein the output circuit includes a plurality of output interfaces and the switch circuit is configured to control on and off of at least one of the output interfaces.

12. The video decoder of claim 11, further comprising:
a detection circuit configured to detect at least one of a throughput of the output interfaces connected to a bus, an operating frequency of a system that the video decoder is working with, an operating frequency of the video decoder, or a format of image data in the stream;
wherein the switch circuit is further configured to control on and off of the at least one of the output interfaces according to information detected by the detection circuit.

13. The video decoder of claim 1, wherein the stream dividing circuit, the processing circuit, and the inverse transform circuit are data processing circuits of the video decoder that are in a serial connection, each of the data processing circuits in the serial connection being configured to:
detect a ready signal sent by a post-stage circuit of the data processing circuit;
start processing target data in response to the ready signal being detected as valid; and
send processed data to a post-stage circuit.

14. The video decoder of claim 13, wherein each of the data processing circuits is configured such that a processing time of the target data and a sending time of the processed data partially overlap.

15. The video decoder of claim 13, wherein each of the data processing circuits and the corresponding post-stage circuit are connected through a data line and a data valid line, and the data processing circuit is configured to send the processed data to the corresponding post-stage circuit through the data line in response to a signal on the data valid line being valid.

16. A method for manufacturing a video decoder comprising:
providing a stream dividing circuit configured to divide a received stream to obtain a plurality of sub-streams;
providing a processing circuit at an output end of the stream dividing circuit, the processing circuit including a plurality of processing units configured to perform entropy decoding and inverse quantization on the plurality of sub-streams in parallel to obtain inversely quantized data;
providing an inverse transform circuit at an output end of the processing circuit, the inverse transform circuit being configured to inversely transform the inversely quantized data to obtain inversely transformed data; and
providing an output circuit at an output end of the inverse transform circuit, the output circuit being configured to output a decoded video according to the inversely transformed data.

17. The method of claim 16, wherein the processing units are configured to perform the parallel entropy decoding and inverse quantization on data in the corresponding sub-streams for each color component.

18. The method of claim 16, wherein the color component includes a color component in an RGB color space or a color component in a YUV color space.

19. The method of claim 16, wherein the inverse transform circuit is configured such that a processing speed of the inverse quantization data by the inverse transform circuit matches a processing speed of the processing circuit on the plurality of sub-streams.

20. A data processing circuit comprising:
an interface circuit configured to be connected to a post-stage circuit of the data processing circuit; and
a processing circuit configured to:
detect a ready signal sent by the post-stage circuit;
start processing target data in response to the ready signal being valid; and
send processed data to the post-stage circuit.
